(19) United States
(12) Patent Application Publication
(10) Pub. No.: US 2004/0156404 A1
(43) Pub. Date: Aug. 12, 2004

(54) Dispersion element for laser pulse compression device using planar photonic crystal structure (embodiments)

(76) Inventors: Sergey A. Kuchinsky, St. Petersburg (RU); Leonid A. Nesterov, St. Petersburg (RU)

Correspondence Address: CORNING INCORPORATED, SP-TI-3-1, CORNING, NY, 14831

(21) Appl. No.: 10/695,960

(22) Filed: Oct. 28, 2003

(30) Foreign Application Priority Data
Nov. 11, 2002 (RU) 2002130193

(51) Int. Cl. H01S 3/10

(52) U.S. Cl. 372/26

(57) ABSTRACT

The invention relates to laser technology and fiber optics. A dispersion element based on a planar photonic crystal structure formed in a layer of a high index material is disclosed. The planar photonic structure in one embodiment comprises a plurality of parallel grooves with a predetermined width and depth, wherein a pulse propagates perpendicular to the grooves, and a length of the dispersion element is defined so that to provide maximum compression of a phase-modulated pulse. The periodic structure in accordance with a second embodiment comprises a two-dimensional periodic structure shown in FIG. 8, sites of the structure having first holes 5 equal to each other and forming columns, and second holes 6 equal to each other and forming a predetermined number of adjacent columns, the sizes of the first holes being different from that of the second holes, wherein the sizes of the first and second holes and refractive indexes of the high index material and the substrate are defined so that to provide guided propagation of the phase-modulated pulse in one-mode operation along the columns of the second holes in the above structure, and a length of the dispersion element in the second embodiment is defined so that to provide maximum compression of a phase-modulated pulse.

The present invention pertains to laser technology and fiber optics and is applicable for designing compact short-wave laser systems (from several femtoseconds to several picoseconds), and more specifically, for designing compact light pulse compressors based on planar photonic crystal structures that may be used to create advanced miniature solid-state pulse laser systems.

At the present time, photonic crystals are being extensively researched as a new kind of artificially engineered, structurally-organized media with 3D periodicity of optical properties, wherein unit crystal cells have dimensions of the order of the optical wave length. Owing to periodic modulation of their refractive index, photonic crystals exhibit peculiar light wave propagation modes within certain ranges of wavelengths and wave vectors. The photonic crystal properties have been actively studied recently as to the possibility of their use in various applications, including spontaneous radiation control, designing vertical cavity semiconductor lasers, Bragg reflectors and chirped mirrors, low-threshold optical switches and limiters, as well as nonlinear diodes. Dispersion elements are known that use photonic crystal structures and comprise a periodic structure formed of periodically alternating layers with different refractive indexes (Zheltikov A. M. et al., “Light Pulse Compression in Photonic Crystals”, Quantum Electronics, 25, No.10, pages 885-890, 1998).

The authors studied whether it is possible to control a phase and duration of short laser pulses using the aforementioned dispersion elements. Pulse compression and phase modulation in one-dimensional structures with photonic band gaps were analytically investigated. The authors presented in the article the results of investigating the opportunities of the dispersion elements based on photonic crystals with cubic optical non-linearity, which allow the duration of laser pulses to be reduced to the values as small as few optical field periods at typical spatial scales less than a millimeter.

Andreev A. V. et al. in work “Femtosecond Light Pulse Compression in Thin One-dimensional Photonic Crystal”, Letters to JETP, vol.71, issue 9, pages 539-543, 2000, described a dispersion element using a layered periodic structure with a modulated refractive index and/or nonlinear sensitivity. Use of the dispersion element based on a 1D photonic crystal with layered periodic structure having a highly modulated linear refractive index permits the compression of femtosecond laser pulses at 4.8 μm crystal length.

The aforementioned prior art pulse compression devices using a dispersion element in the form of a photonic crystal structure, however, have a number of drawbacks, in particular: they have quite thick (several mm) layered periodic structures that are elaborated and expensive, and the structures cannot be integrated in a planar integrated optical circuit.

In light of the foregoing, the object of the present invention is to provide a dispersion element for a pulse compression device using a planar photonic crystal structure having a pulse geometric path length of several millimeters, that can be integrated in a planar integrated optical circuit with a high pulse compression attained at minimum diffraction loss.

The above object is attained in a dispersion element for a laser pulse compression device adapted to compress a phase-modulated pulse, the dispersion element being based on a planar photonic crystal structure in the form of an one-dimensional (1D) periodic structure formed in a layer of a high index material of a predetermined thickness with refractive index n₂, the high index material being deposited on a substrate with refractive index n₁, at n₂>n₁; the periodic structure comprising a plurality of equally spaced parallel grooves of a predetermined width and depth made in the high index layer, wherein the pulse propagates in the dispersion element perpendicularly to the grooves, and a length of the dispersion element is defined so that to provide maximum compression of the phase-modulated pulse.

The periodic structure can be covered with a protective layer of a material with predetermined refractive index n₃ to provide mechanical strength and reduce scattering loss, where n₃<n₂ by a value providing guided propagation of the pulse in a single-mode operation.

Furthermore, length L of the dispersion element that provides maximum pulse compression is defined in accordance with the theory disclosed by B. Saleh, M. Teich in “Fundamentals of Photonics”, John Wiley&Sons, Inc., 1991, Chapter 5, page 188, from the expression:

$$\frac{{( {a}_{0} {T}^{2} )}^{2}}{[ 1 + ( {a}_{0} {T}^{2} ) ] {a}_{0} {k}^{″}} \qquad ( 1 )$$

where k″ is the group velocity dispersion in a photonic crystal structure, a₀ is the phase velocity of the phase-modulated pulse, T is the duration of a pulse entering the dispersion element.

According to the second embodiment of the invention, the above object is attained in a dispersion element for a laser pulse compression device adapted to compress a phase-modulated pulse, the dispersion element being based on a planar photonic crystal structure in the form of a two-dimensional (2D) periodic structure with predetermined period a formed in a layer of a high index material having a predetermined thickness and refractive index n₂, the layer being deposited on a substrate with refractive index n₁, at n₂>n₁, sites of the 2D periodic structure having first holes of a predetermined equal size forming columns, and second holes having a predetermined size different from that of said first holes and forming a predetermined number of adjacent columns, the sizes of the first and second holes and the refractive indexes being defined so that to provide guided propagation of the phase-modulated pulse in a single-mode operation along the columns of the second holes of the structure, and a length of the dispersion element being defined so that to provide maximum compression of the phase-modulated pulse.

Furthermore, the 2D periodic structure is selected from a trigonal, rectangular or square periodic lattice.

The periodic structure can be covered with a protective layer of a material with predetermined refractive index n₃ to render mechanical strength and reduce scattering loss. Length L of the dispersion element is defined from the expression:

$$\frac{{( {a}_{0} {T}^{2} )}^{2}}{[ 1 + ( {a}_{0} {T}^{2} ) ] {a}_{0} {k}^{″}} \qquad ( 1 )$$

where k″ is the group velocity dispersion in a photonic crystal structure, a₀ is the phase velocity of the phase-modulated pulse, T is the duration of a pulse entering the dispersion element.

Depth of the first holes at the sites of the periodic structure can be equal, less or greater than a thickness of the high index material layer, and distances between the centers of the second holes and the centers of nearest first holes at the periodic structure sites may differ from the period a of said lattice.

Depth of the second holes at the 2D periodic structure sites can be less, equal or greater than the thickness of the high index layer, as well as the depth of the first holes.

The first and second holes according to the second embodiment made at the sites of the 2D periodic structure are in the shape of circular cylinders.

The second holes form a single column in said 2D periodic structure, over which column the phase-modulated pulse accomplishes guided propagation in single-mode operation.

The features, objects and advantages of the present invention will become more apparent from the detailed description set forth below when taken in conjunction with the drawings in which like reference characters identify correspondingly throughout and wherein:

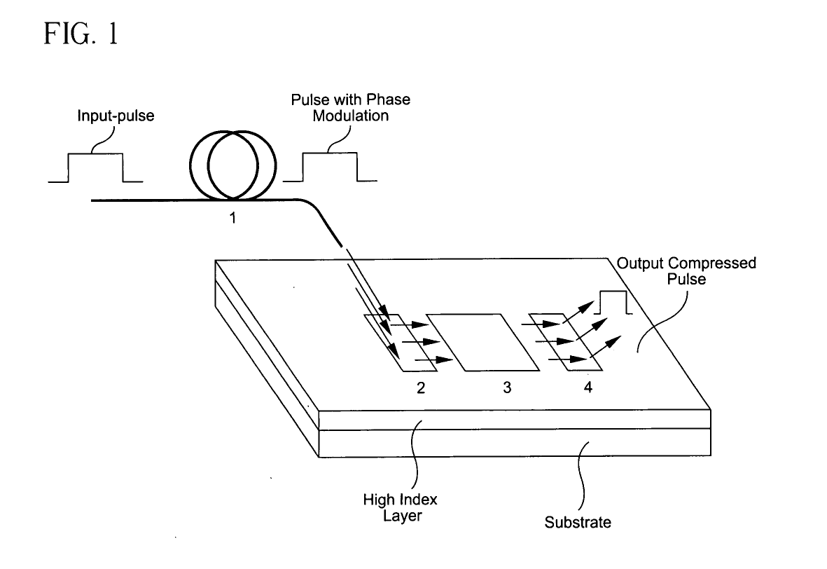

FIG. 1 is a schematic diagram of a pulse compression device with a dispersion element using a planar photonic crystal structure with 1D periodicity.

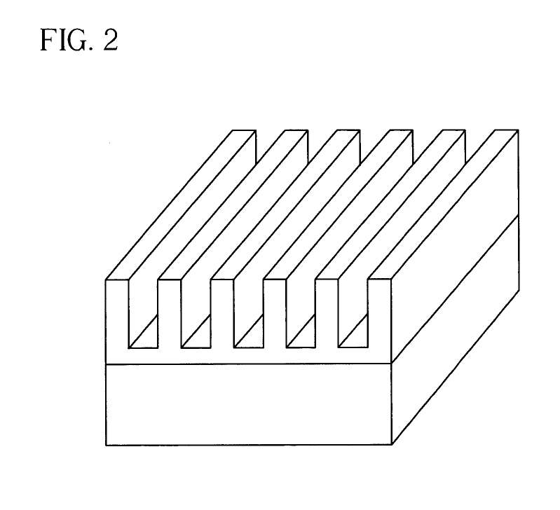

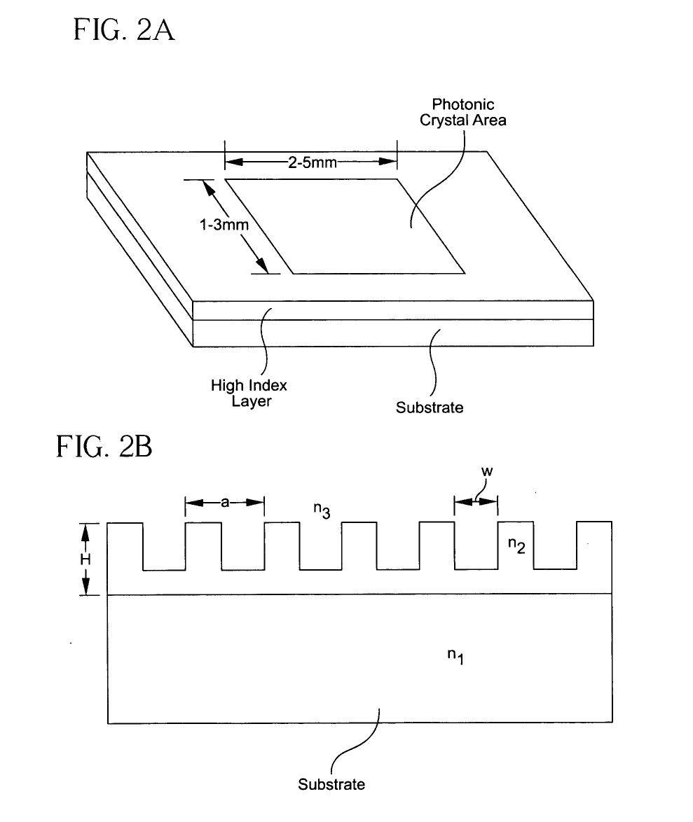

FIG. 2 is a schematic diagram of a first embodiment of dispersion element using a planar photonic crystal structure with 1D periodicity, in accordance with the invention.

FIG. 2a is a general view of a dispersion element structure according to FIG. 2, FIG. 2b is a vertical sectional view of the dispersion element according to FIG. 2.

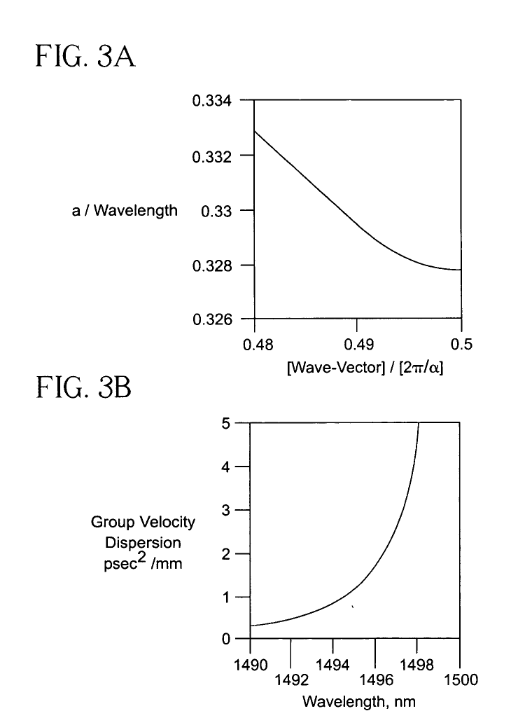

FIGS. 3A and 3B are plots obtained by modeling photon zones in a planar photonic crystal structure with 1D periodicity (first example), where A is a dispersion curve for a negative dispersion one-mode operation for TE-polarization, B is a spectral dependence of the group velocity dispersion (k″_{pc}) for TE polarization.

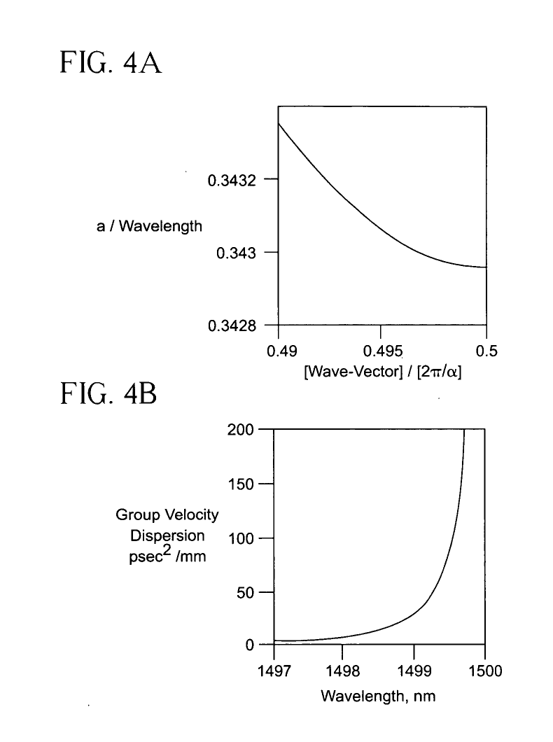

FIGS. 4A and 4B are plots obtained by modeling photon zones in a planar photonic crystal structure with 1D periodicity (second example), where A is a dispersion curve for a negative dispersion one-mode operation for TE polarization, B is a spectral dependence of the group velocity dispersion (k″_{pc}) for TE polarization.

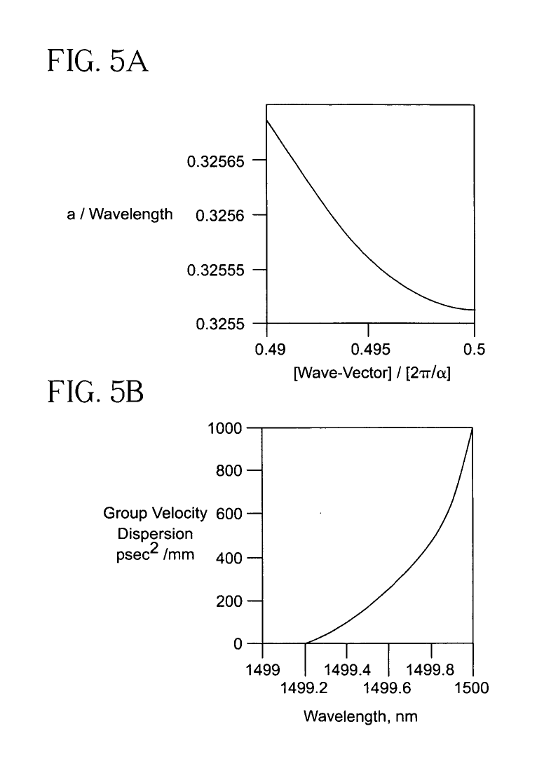

FIGS. 5A and 5B are plots obtained by modeling photonic zones of a planar photonic crystal structure with 1D periodicity (third example), where A is a dispersion curve for a negative dispersion one-mode operation for TM polarization, B is a spectral dependence of the group velocity dispersion (k″_{pc}) for TM polarization.

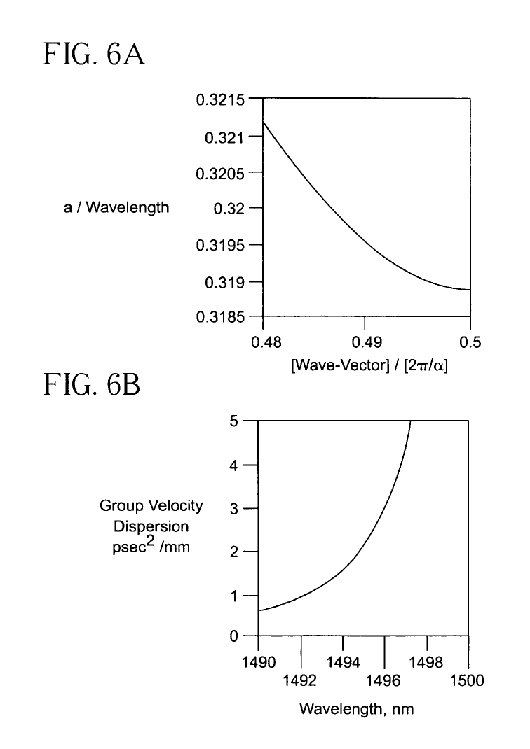

FIGS. 6A and 6B are plots obtained by modeling photonic zones in a planar photonic crystal structure with 1D periodicity (forth example), where A is a dispersion curve for a negative dispersion one-mode operation for TE polarization, B is a spectral dependence of the group velocity dispersion (k″_{pc}) for TE polarization.

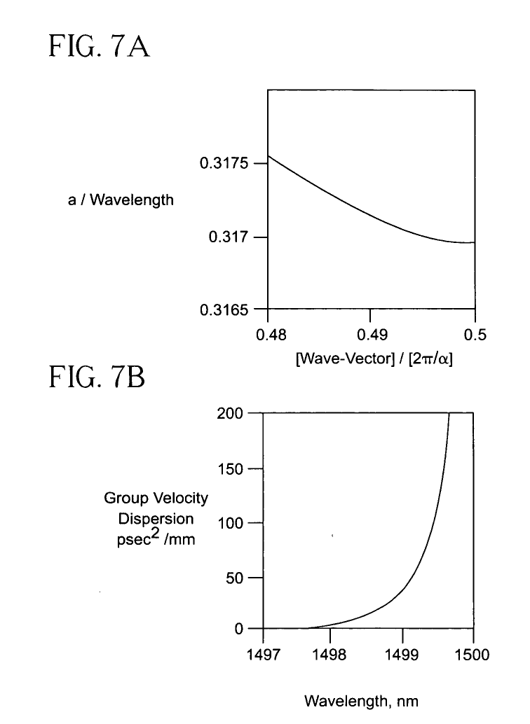

FIGS. 7A and 7B are plots obtained by modeling photonic zones in a planar photonic crystal structure with 1D periodicity (fifth example), where A is a dispersion curve for a negative dispersion one-mode operation for TM polarization, B is a spectral dependence of the group velocity dispersion (k″_{pc}) for TM polarization.

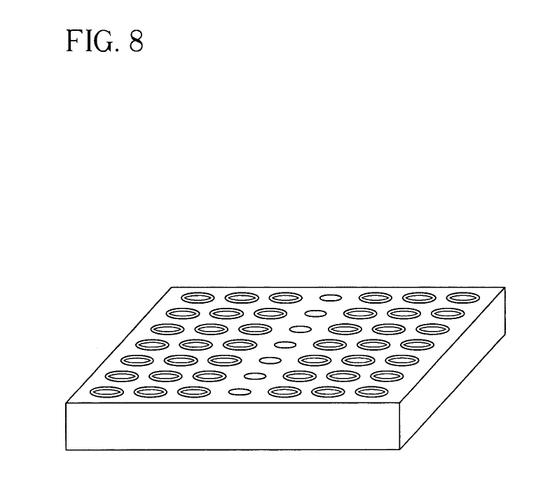

FIG. 8 is a structure of a dispersion element based on a planar photonic crystal structure with 2D periodicity according to a second embodiment of the invention.

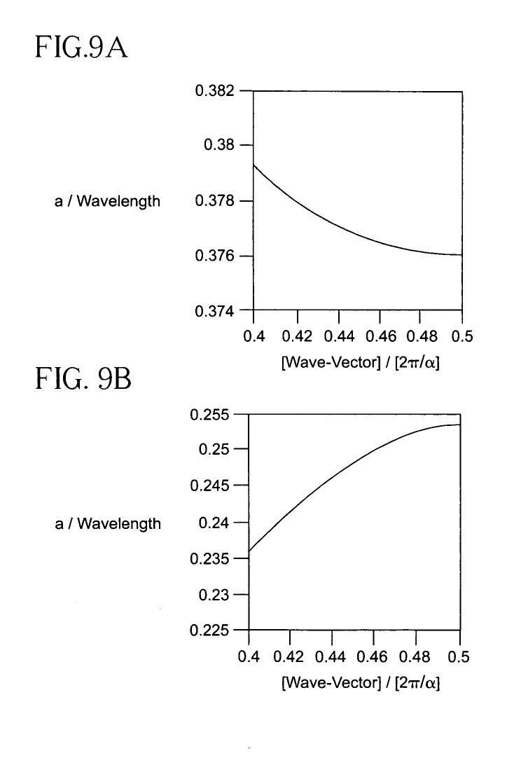

FIGS. 9A and 9B are dispersion curves (light frequency versus wave vector) of waveguide modes localized at the second holes, obtained by modeling photon zones with TM polarization in a planar photonic crystal structure with 2D periodicity, where A is a negative dispersion mode, and B is a positive dispersion mode.

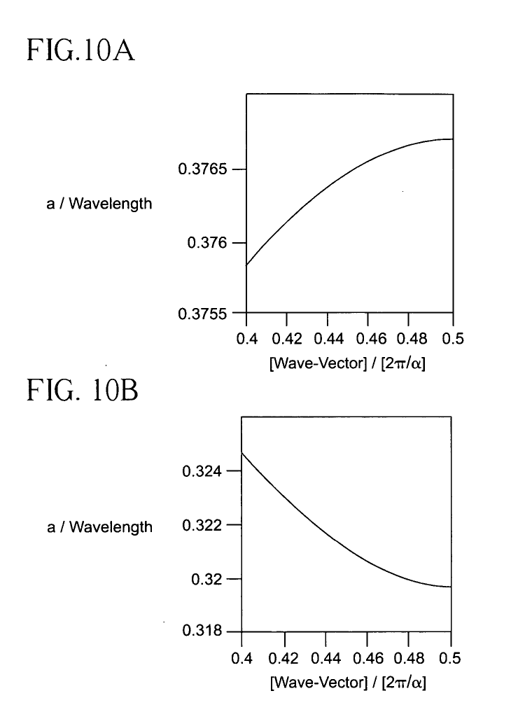

FIGS. 10A and 10B are dispersion curves (light frequency versus wave vector) of waveguide modes localized at the second holes, obtained by modeling photonic zones with TM polarization in a planar crystal structure with 2D periodicity, where A is a positive dispersion mode, and B is a negative dispersion mode.

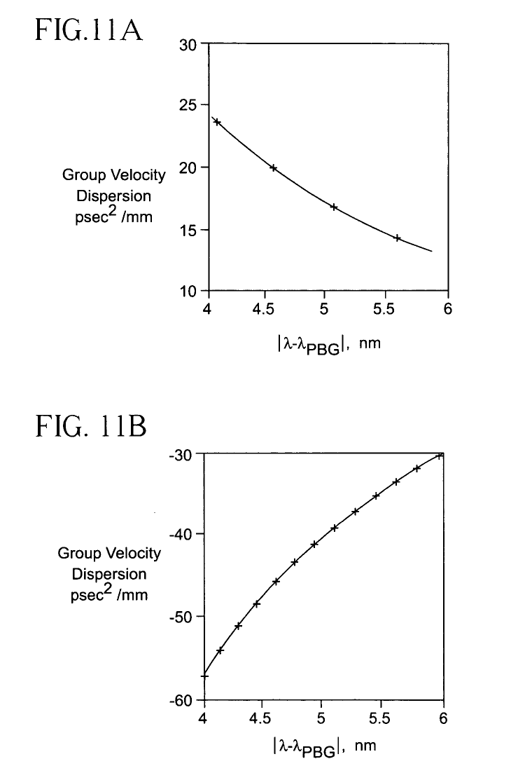

FIGS. 11A and 11B are dispersion curves (light frequency versus wave vector) of waveguide modes localized at the second holes, obtained by modeling photonic zones with TM polarization in a planar photonic crystal structure with 2D periodicity, where A is a positive dispersion mode, and B is a negative dispersion mode.

Referring now to the drawings in detail, FIG. 1 shows a pulse compression device as an example of a device in which a first embodiment of a dispersion element is used. The device comprises a nonlinear element 1 such as a length of a nonlinear optical fiber for modulating the phase of an input pulse, a transition element 2, a diffraction grating, for injecting the phase-modulated pulse exiting the nonlinear element 1 into a high index layer of a dispersion element 3, and an output element 4, a diffraction grating, for outputting the pulse from the high index layer of the dispersion element 3.

FIGS. 2, 2A, 2B illustrate a first embodiment comprising a dispersion element made as a planar photonic crystal structure such as 1D periodic structure formed in a plane-parallel layer of a high index material having a predetermined thickness and refractive index n₂, said layer being deposited on a substrate having refractive index n₁, at n₂>n₁, wherein the periodic structure comprises a plurality of equally spaced parallel grooves (see FIG. 2) formed in the high index layer, the pulse propagating through the dispersion element perpendicularly to the grooves, length L of the dispersion element providing a maximum pulse compression is defined in accordance with the theory disclosed by B. Saleh, M. Teich in work “Fundamentals of Photonics”, John Wiley&Sons, Inc., 1991, Chapter 5, page 188) from the expression:

$$\frac{{( {a}_{0} {T}^{2} )}^{2}}{[ 1 + ( {a}_{0} {T}^{2} ) ] {a}_{0} {k}^{″}} \qquad ( 1 )$$

where k″ is the group velocity dispersion in a photonic crystal structure, calculated by the formula:

$${k}^{″} = \frac{{\partial }^{2} K}{\partial {ω}^{2}}$$

where k is the wave vector, \overline{ω} is the light frequency, dispersion curve k(ω) being modeled using “MIT Photonic Bands” software, a0 is the phase velocity of the phase-modulated pulse, T is the duration of the pulse entering the dispersion element.

FIGS. 3 to 7 show plots illustrating the mathematical modeling results for the optical pulse compression in the dispersion element according to the first embodiment.

FIG. 8 shows a second embodiment of the invention in which a dispersion element comprises a planar photonic crystal structure with 2D periodicity. The structure is formed in a plane-parallel layer of a high index material having a predetermined thickness and refractive index n₂, the layer being deposited on a substrate with refractive index n₁, at n₂>n₁, wherein the structure is a 2D periodic lattice with predetermined period a, sites of the lattice have first holes 5 having a predetermined equal size and forming columns, and second holes 6 having a predetermined equal size different from that of the first holes and forming a predetermined number of adjacent columns.

FIGS. 9 to 11 show plots obtained by modeling the optical pulse compression in the second embodiment of the dispersion element.

Operation of a dispersion element according to the first embodiment (see FIGS. 2, 2A, 2B) will be further described using as the example the pulse compression device shown in FIG. 1. A phase-modulated pulse generated in a nonlinear element 1, a length of nonlinear optical fiber, passes to a transition element 2, a diffraction grating, which injects the phase-modulated pulse exiting the nonlinear element 1 into a high index layer of a dispersion element 3 according to the first embodiment, which is the subject matter of the present invention, wherein the pulse propagates perpendicular to grooves in the 1D planar photonic crystal structure. Owing to the high group velocity dispersion in the dispersion element (see FIGS. 3 to 7) the phase modulation changes to amplitude modulation, thereby significantly reducing the duration of the pulse. The resulting pulse then passes to an output element 4 shown in FIG. 1, a diffraction grating, that outputs the pulse from the high index layer of the diffraction element 3.

The planar photonic crystal structure has the following parameters: substrate refractive index (n₁), high index layer refractive index (n₂), protection layer refractive index (n₃), if there is no protection layer, n₃=1, (it should noted that the presence of the protective layer reduces scattering loss and can improve mechanical strength), high index layer thickness (H), groove depth (h), groove width (w), structure period, i.e. distance between centers of adjacent grooves, (a) (see FIGS. 2a, 2b), and dispersion element length (L) in the direction normal to the grooves. The above parameters were determined by a mathematical modeling method using “MIT Photonic bands” software (http://abinitio.mit.edu/mpb) such that to provide guided propagation of the pulse in one-mode operation and a high group velocity dispersion. The software is based on the flat wave decomposition method and enables numerical experiments to be carried out to determine dispersion curves of waveguide modes in planar photonic crystal structures. The above experiments were conducted for modes propagating normally to the grooves in the planar photonic crystal structure with 1D periodicity within a wide range of variation of parameters n₁, n₂, n₃, H, a, r₀, h₀, w, a. Analysis of the numerical experiments has shown that it is possible to provide one-mode guided propagation of light having a specified polarity and wavelength within a predetermined operation range (λₘₐₓ, λₘᵢₙ) that is assessed using the presented dispersion curve plots by the formula: λₘₐₓ=a/ωₘₐₓ, λₘᵢₙ=a/ωₘᵢₙ, where ωmax and ωmin are the maximum and minimum value of a dimensionless light frequency (a/wavelength), respectively, on the dispersion curve plots, and a required sign of the group velocity dispersion. Results of the experiments are shown in FIGS. 3 to 7.

FIG. 3 shows calculations of spectral characteristics of a planar photonic crystal structure made as an 1D periodic structure formed by parallel grooves in a high index material layer with the following parameters: a=491.7 nm, H=h, w=0.5 a, n₁=n₃=1.5, n₂=2.3, where FIG. 3A shows a dispersion curve for negative dispersion one-mode operation for TE polarization, and FIG. 3B shows a spectral dependence of group velocity dispersion k″_{pc} for TE polarization.

FIG. 4 shows calculations of spectral characteristics of a planar photonic crystal structure made as an 1D periodic structure formed by parallel grooves in a high index material layer with the following parameters: a=514.4 nm, H=1.0 a, h=0.8 a, w=1.0 a, n₁=n₃=1.5, n₂=2.3, where FIG. 4A shows a dispersion curve for a negative dispersion one-mode operation for TE polarization, and FIG. 4B shows a spectral dependence of group velocity dispersion k″_{pc} for TE polarization.

FIG. 5 shows calculations of spectral characteristics of a planar photonic crystal structure made as an 1D periodic structure formed by parallel grooves in a high index material layer with the following parameters: a=488.3 nm, H=h, w=0.5 a, n₁=n₃=1.5, n₂=2.3, where FIG. 5A shows a dispersion curve for a negative dispersion one-mode operation for TM polarization, and FIG. 5B shows a spectral dependence of group velocity dispersion k″_{pc} for TM polarization.

FIG. 6 shows calculations of spectral characteristics of a planar photonic crystal structure made as an 1D periodic structure formed by parallel grooves in a high index material layer with the following parameters: a=478.3 nm, H=h=1.0 a, w−0.5 a, n₁=n₃=1.5, n₂=2.3, where FIG. 6A shows a dispersion curve for a negative dispersion one-mode operation for TE polarization, and FIG. 6B shows a spectral dependence of group velocity dispersion k″_{pc} for TE polarization.

FIG. 7 shows calculations of spectral characteristics of a planar photonic crystal structure made as a 1D periodic structure formed by parallel grooves in a high index material layer with the following parameters: a=475.4 nm, H=h, w=1.0 a, n₁=n₃=1.5, n₂=2.3, where FIG. 7A shown a dispersion curve for a negative dispersion one-mode operation for TM polarization, and FIG. 7B shows a spectral dependence of group velocity dispersion k″_{pc} for TM polarization.

Length of the dispersion element along the pulse propagation direction is determined from the expression (1) taking into account the duration and the group velocity dispersion in the dispersion element computed by “MIT Photonic bands” software.

FIG. 8 shows a second embodiment of the invention, a dispersion element made as a planar photonic crystal structure with 2D periodicity. The structure is formed in a plane-parallel layer of a high index material having a predetermined thickness and refractive index n₂, deposited on a substrate with refractive index n₁, where n₂>n₁. The structure is a 2D periodic lattice with predetermined period a, sites of the lattice having first holes 5 of a predetermined equal size, forming columns, and second holes 6 of a predetermined equal size different from that of the first holes, the second holes forming a predetermined number of adjacent columns.

Length L of the dispersion element providing a maximum pulse compression is defined in accordance with the theory disclosed by B. Saleh, M. Teich in “Fundamentals of Photonics”, John Wiley&Sons, Inc., 1991, Chapter 5, page 188) from the expression:

$$\frac{{( {a}_{0} {T}^{2} )}^{2}}{[ 1 + ( {a}_{0} {T}^{2} ) ] {a}_{0} {k}^{″}} \qquad ( 1 )$$

where k″ is the group velocity dispersion in a photonic crystal structure, calculated by the formula:

$${k}^{″} = \frac{{\partial }^{2} K}{\partial {ω}^{2}}$$

where k is the wave vector, ω is the light frequency, the dispersion curve k(ω) being modeled using “MIT Photonic Bands” software, a₀ is the phase velocity of the phase-modulated pulse, T is the duration of the pulse entering the dispersion element.

The dispersion element according to the second embodiment of the invention operates as follows. The operation of the device is described at the example of the dispersion element having a predetermined single column formed of the second holes, as shown in FIG. 8. A phase-modulated pulse passes to the dispersion element according to the second embodiment, wherein it propagates over the column formed by the second holes 6 (see FIG. 8), the pulse propagation can be compared to pulse propagation over a waveguide. Owing to the high group velocity dispersion in the dispersion element, as shown in FIG. 11, the phase modulation changes to amplitude modulation, thereby reducing the duration of the pulse.

The structure of the dispersion element according to the second embodiment is defined by the following parameters: substrate refractive index (n₁), high index layer refractive index (n₂), protective layer refractive index (n₃), if there is no protective layer n₁, high index layer thickness (H), 2D periodic lattice type, e.g. the lattice may be trigonal, rectilinear or square, structure period, i.e. the distance between centers of adjacent grooves, (a). This embodiment relates to the case where the first and second holes are in the shape of circular cylinders, the first holes having radius (r₀) and depth (h₀), wherein the depth of the first hole may be less, equal or greater than the high index layer thickness. The first holes should be of the same size. In the second embodiment, the second holes have radius (r_{w}) and depth (h_{w}), wherein the depth of the second holes may be less, equal or greater than the thickness of the high index layer and the depth of the first holes. The second holes are of the same size. Distances between the centers of the second holes and the centers of the nearest first holes may differ from the structure period a.

Parameters n₁, n₂, n₃, H, a, r₀, h₀, r_{w}, h_{w} are defined so that to provide one-mode propagation of a pulse of a predetermined polarization and wavelength in the specified (operating) spectral range along the second holes, as well as a great magnitude and required sign of the group velocity dispersion, specifically, negative value of the group velocity dispersion for positive value of the phase velocity of the pulse exiting the nonlinear element, and positive value of the group velocity dispersion for negative value of the phase velocity of the pulse exiting the nonlinear element. According to the formula (1) the magnitude of the group velocity dispersion should be sufficient to provide maximum pulse compression at a predetermined length of the dispersion element.

Qualitative values of the above parameters observing the specified conditions are determined using mathematical modeling of light propagation in the second embodiment of the dispersion element. Modeling is performed using “MIT Photonic bands” software. The software, as mentioned above, is based on flat wave decomposition method and allows numerical experiments to be carried out for defining dispersion curves of waveguide modes in planar photonic crystal structures. The experiments were performed for modes propagating over the second holes of the photonic crystal structure with 2D periodicity within a wide range of variation of parameters n₁, n₂, n₃, H, a, r₀, h₀, r_{w}, h_{w}. Analysis of the numerical experiments has shown that it is possible to provide one-mode guided propagation of light having a predetermined polarization and wavelength in a specified (operating) spectral range, and a required sign of the group velocity dispersion. In this case, light propagates along the second holes.

Results of the experiments are illustrated in FIGS. 9 to 11. FIG. 9 shows an example of calculated dispersion curves of waveguide modes in the second holes forming a single column. In this example, FIG. 9A illustrates a negative dispersion mode, and FIG. 9B illustrates a positive dispersion mode. The structure has the following parameters: trigonal 2D lattice, n₁=1, n₂=3.4, n₃=1.0, H=h₀=h_{w}=0.5 a, r₀/a=0.4, r_{w}/a=0.3, i.e. the second holes in this example have a smaller diameter than the first holes. One-mode propagation is provided in this example, the light being localized on the column formed by the second holes in the 2D photonic crystal structure. A particular case where one column of the second holes is omitted in the 2D planar photonic crystal structure (mathematically this case corresponds to r_{w}=0, where r_{w} is the radius of the second holes) and the pulse propagates along the omitted column in the photonic crystal structure is illustrated in FIGS. 10A and 10B showing dispersion curves (light frequency versus wave vector) of waveguide modes localized at the second holes, obtained by modeling photon zones with TM polarization in a planar crystal structure with 2D periodicity, where A illustrates a positive dispersion mode, and B illustrates a negative dispersion mode. The structure parameters are defined as follows: trigonal 2D lattice, n₁=1.0, n₂=3.4, n₃=1.0, H=h₀=h_{w}=0.5 a, r₀/a=0.4, r_{w}=0.

The above choice of parameters provides one-mode propagation wherein the light is localized at the second holes forming a column in the 2D photonic crystal structure.

FIGS. 11(A,B) shows an example of calculated curves of the group velocity dispersion of waveguide modes in the second holes forming a single column. In this example, A illustrates a positive dispersion mode, and B illustrates a negative dispersion mode. The structure parameters are defined as follows: trigonal 2D lattice, n₁=1.0, n₂=3.4, n₃=1.0, H=h₀=h_{w}=0.5 a, r₀/a=0.4, r_{w}/a=0.3, i.e. in this example the second holes are of a smaller diameter than the first holes. In the example, one-mode propagation is provided with the light localized on a column formed by the second holes in the 2D photonic crystal structure.

The embodiments of the dispersion element in accordance with the invention, using a planar photonic crystal structure with 1D or 2D periodicity, can be naturally integrated into a single chip optical device using conventional ways for coupling elements of the circuit, and can be fabricated by well-designed nanolithography methods. This ensures the creation of a dispersion element having a greater length than the prior art layered structure designs, with a greater pulse compression attained. The use of “wave-guiding effect” in the device according to the invention allows the light to be concentrated in the propagation direction and considerable diffraction loss be avoided. The apparatus can be successfully employed in solid-state short-pulse laser systems.

What is claimed is:

1. A dispersion element for a laser pulse compression device adapted to compress a phase-modulated pulse, said dispersion element being based on a planar photonic crystal structure made as an one-dimensional (1D) periodic structure formed in a layer of a high index material having a predetermined thickness and refractive index n₂, the high index material layer being deposited on a substrate with refractive index n₁, at n₂>n₁, the periodic structure comprising a plurality of parallel grooves having a predetermined width and depth, made in the high index layer at equal distance from each other, wherein the pulse propagates in the dispersion element perpendicularly to the grooves, and a length of the dispersion element is defined so that to provide maximum compression of the phase-modulated pulse.

2. The dispersion element as set forth in claim 1, wherein said periodic structure is covered with a protective layer made of a material with predetermined refractive index n₃ to provide mechanical strength and reduce scattering loss, where n₃<n₂ by a value providing guided propagation of the pulse in single-mode operation.

3. The dispersion element as set forth in claim 1, wherein length L of the dispersion element is defined from the expression:
$$\frac{{( {a}_{0} {T}^{2} )}^{2}}{[ 1 + ( {a}_{0} {T}^{2} ) ] {a}_{0} {k}^{″}}$$
where a₀ is the phase velocity of the phase-modulated pulse, k″ is the group velocity dispersion in 1D planar photonic crystal structure, T is the duration of an input pulse.

4. A dispersion element for a laser pulse compression device adapted to compress a phase-modulated pulse, said dispersion element being based on a planar photonic crystal structure made as a two-dimensional periodic structure with predetermined period a, formed in a layer of a high index material having a predetermined thickness and refractive index n₂, the high index material layer being deposited on a substrate with refractive index n₁, at n₂>n₁, sites of the 2D periodic structure having first holes of a predetermined equal size, forming columns, and second holes of a predetermined equal size different from that of said first holes, forming a predetermined number of adjacent columns, wherein said sizes of the said and second holes and said refractive indexes are defined so that to provide guided propagation of the phase-modulated pulse in single-mode operation along the columns of the second holes in the structure, and a length of the dispersion element is defined so that to provide maximum compression of the phase-modulated pulse.

5. The dispersion element as set forth in claim 4, wherein said 2D periodic structure is selected from a trigonal, rectangular or square periodic lattice.

6. The dispersion element as set forth in claim 4, wherein said 2D periodic structure is covered with a protective layer of a material with predetermined refractive index n₃ to render mechanical strength and reduce scattering loss.

7. The dispersion element as set forth in claim 4, wherein length L of the dispersion element is defined from the expression:
$$\frac{{( {a}_{0} {T}^{2} )}^{2}}{[ 1 + ( {a}_{0} {T}^{2} ) ] {a}_{0} {k}^{″}}$$
where a₀ is the phase velocity of the phase-modulated pulse, k″ is the group velocity dispersion in 1D planar photonic crystal structure, T is the duration of an input pulse.

8. The dispersion element as set forth in claim 4, wherein the depth of the first holes at the sites of said periodic structure can be equal, less or greater than the thickness of the high index material layer.

9. The dispersion element as set forth in claim 4 or 8, wherein the depth of the second holes at the sites of said periodic structure can be less, equal or greater that the thickness of the high index layer, as well as the depth of the first holes.

10. The dispersion element as set forth in claim 4, wherein distances between centers of the second holes and centers of the nearest first holes at the periodic structure sites can differ from the period a of said structure.

11. The dispersion element as set forth in claim 4, wherein said first and second holes at the 2D periodic structure sites are in the shape of circular cylinders.

12. The dispersion element as set forth in claim 4, wherein said second holes form a single column in said 2D periodic structure, over which column the phase-modulated pulse accomplishes guided propagation in single-mode operation.
